(19) United States
(12) Patent Application Publication
(10) Pub. No.: US 2005/0009686 A1
(43) Pub. Date: Jan. 13, 2005

(54) Ceramic heat exchanger

(76) Inventors: Stein Julsrud, Skien (NO); Bent Erlend Vigeland, Skien (NO)

Correspondence Address: WENDEROTH, LIND & PONACK, L.L.P., 2033 K STREET N. W., SUITE 800, WASHINGTON, DC, 20006-1021, US

(21) Appl. No.: 10/492,752

(22) PCT Filed: Sep. 25, 2002
(86) PCT No.: PCT/NO02/00339

(30) Foreign Application Priority Data
Oct. 19, 2001 (NO) 20015135

(51) Int. Cl. C04B 35/03

(52) U.S. Cl. 501/152; 501/94

(57) ABSTRACT

The present invention relates to a ceramic heat exchanger manufactured from an oxide material that is highly refractory and highly stable in a wide range of oxygen partial pressures and in the presence of certain gases and which is capable of operating at temperatures ranging from below 400 to well above 1300° C. for a prolonged period of time. The oxide material is represented by the formula:
A₁₋ₓBₓO_{(3+x+z)/2} where A is selected from the group consisting of La, Ce, Pr, Nd, Pm, Sm, Eu, Gd, Tb, Dy, Ho, Er, Tm, Yb, Lu, Y, and mixtures thereof, B represents Zr, Ti or Hf or mixtures thereof, x is greater than or equal to zero and less than or equal to one, and z is a number that renders the compound charge neutral and is greater than about −0.1 and less than about 0.2.

The present invention relates to ceramic materials for heat exchangers which are generally applicable, but which are particularly suited in applications with high temperatures and high steam pressures.

Industrial processes frequently operate inefficiently due to waste heat losses from high temperature exhaust gases. Likewise, several potential industrial processes may work at less than optimum efficiency unless heat from high temperature exhaust gases can be recovered. Examples are processes involving steam reforming of natural gas or partial or full oxidation of natural gas. In the absence of heat exchangers capable of operating at sufficiently high temperatures, efficiency is lost either through the lack of waste heat recovery, or through the reduction of process temperatures. In many cases it may be beneficial to generate exhaust gases or product gases having temperatures in the range of 900 to 1200° C., and in certain cases in excess of 1200° C.

It is well known in the art that conventional heat exchangers made from metals and alloys can not be used at temperatures exceeding 800-1000° C. At higher temperatures metal based heat exchangers lack the mechanical strength required for prolonged operation.

Use of certain ceramic materials, however, increases the allowable operating temperature of the heat exchanger. Silicon carbide for example is very refractory with a melting temperature of well above 2000° C. A serious disadvantage with SiC, however, is the potentially fast evaporation of silicon containing gas species from the solid surface when steam is present in the gas. When oxygen (as e.g. O₂, H₂O, CO₂, CO) is present in the gas contacting the SiC heat exchanger, a layer of SiO₂ forms on the surface. This layer is attacked by water and the highly volatile Si(OH)₄ is formed and evaporates from the heat exchanger. This evaporation may have various serious implications. Firstly, the consumption of heat exchanger material will lead to thinning of the walls and may eventually lead to a mechanical failure and cracking of the heat exchanger. Secondly, the evaporated material may condense in cooler parts of the heat exchanger or in cooler parts of other components and lead to clogging of fluid paths, which results in increased pressure losses. Thirdly, Si(OH)₄ may react with or condense in cooler functional components, e.g. catalysts, thereby interfering with the functionality of the component.

All potential heat exchanger materials containing silicon (e.g. Si₃N₄, cordierite) will be associated with these problems caused by the evaporation of Si(OH)₄ when steam is present in the gas.

Moreover, most other ceramic materials will have unacceptably high vapour pressures of metal hydroxide species when used above 1000° C. in the presence of steam. Aluminium nitride, for example, will react with steam and form nitrogen gas and Al(OH)₃ which similarly to Si(OH)₄ is highly volatile.

The main object of the present invention was to develop ceramic compositions (materials) for heat exchangers that are highly refractory and highly stable in a wide range of oxygen partial pressures and in the presence of gases such as CH₄ and other hydrocarbons, H₂O, CO₂, H₂, CO, and O₂ and which are capable of operating at temperatures ranging from below 400 to well above 1300° C. for a prolonged period of time.

Another object of the present invention was to develop ceramic compositions suitable for manufacturing heat exchangers that implies low level of evaporation from the heat exchanger at high temperatures.

The inventors found that certain classes of materials have unique properties and are particularly suitable in heat exchangers for use at high temperatures and in the presence of steam. Materials of these compositions are refractory and have particularly low vapour pressures in the presence of steam.

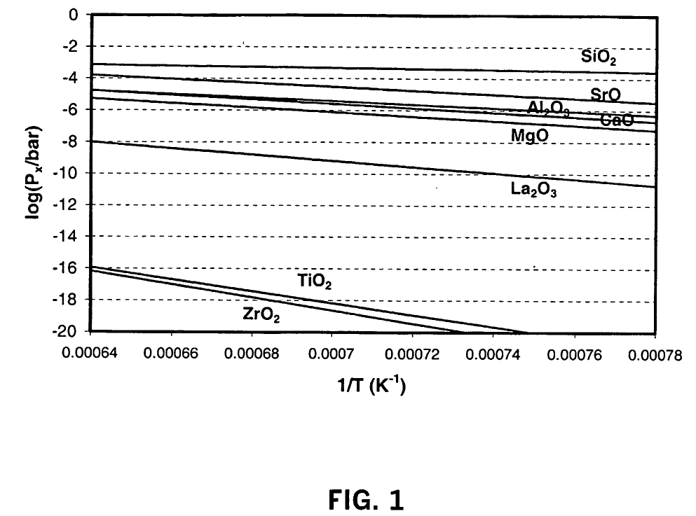

The vapour pressure above a selection of oxides in the presence of steam at a pressure of 12.7 bar and hydrogen at a partial pressure of 0.1 bar is shown as a function of inverse temperature in FIG. 1. It is evident that of the oxides included in FIG. 1, La₂O₃, ZrO₂, and TiO₂ will evaporate at a considerably lower rate than the remaining oxides. A process with a gas flow through the heat exchanger of 1 kmol/s may be taken as an example for the estimation of potential evaporation losses from the heat exchanger. Assuming that the gas flowing through the heat exchanger becomes saturated with the metal oxide or hydroxide in question, the loss at 1250° C. from a SiO₂ surface will be 60 tonnes/year. The loss from a MgO surface will be 200 kg/year, from La₂O₃ 1 kg/year, and from TiO₂ a few micrograms per year. It is evident that the evaporation losses from all oxides in FIG. 1 except La₂O₃, ZrO₂, and TiO₂ will be unacceptably high. Generally, a lowering of the vapour pressure will be observed when the pure oxide in question is a constituent in a multicomponent compound. But a lowering of more than two orders of magnitude is rarely observed.

Of the simple metal oxides not included in FIG. 1, HfO₂ will have vapour pressures close to those expected for TiO₂ and ZrO₂. The vapour pressures of the lanthanide oxides will be similar to the vapour pressure expected for La₂O₃. Y₂O₃ will have lower vapour pressure than La₂O₃. The vapour pressures of all other usable elements will be higher than above MgO, and will hence have unacceptably high vapour pressures in processes in which the temperature exceeds 1000° C. and where steam is present at relatively high pressures.

The scope of the invention in its widest sense is a ceramic heat exchanger manufactured from an oxide material where the material is represented by the formula:
A₁₋ₓBₓO_{(3+x+z)/2}
where A is selected from the group consisting of La, Ce, Pr, Nd, Pm, Sm, Eu, Gd, Tb, Dy, Ho, Er, Tm, Yb, Lu, Y, and mixtures thereof, B represents Zr, Ti or Hf or mixtures thereof, x is greater than or equal to zero and less than or equal to one, and z is a number that renders the compound charge neutral and is greater than about −0.1 and less than about 0.2.

In one embodiment of the present invention the heat exchanger comprises a ceramic oxide material described by the formula
A₁₋ₓBₓO_{(3+x+z)/2}
where B represents Zr, Ti or Hf or mixtures thereof and is at least representing Ti or Hf, x is equal to one and z is less than or equal to zero.

In a second embodiment of the present invention the heat exchanger comprises a ceramic oxide material described by the formula
A₁₋ₓBₓO_{(3+x+z)/2}
where A is selected from the group consisting of La, Ce, Pr, Nd, Pm, Sm, Eu, Gd, Tb, Dy, Ho, Er, Tm, Yb, Lu, Y, and mixtures thereof, x is equal to zero, and z is a number that renders the compound charge neutral and is greater than about −0.1 and less than about 0.2. Preferred compositions have A predominantly representing La.

In a third embodiment of the present invention the heat exchanger comprises a ceramic oxide material described by the formula
A₁₋ₓBₓO_{(3+x+z)/2}
where A is selected from the group consisting of La, Ce, Pr, Nd, Pm, Sm, Eu, Gd, Tb, Dy, Ho, Er, Tm, Yb, Lu, Y, and mixtures thereof, B represents Zr, Ti or Hf or mixtures thereof, x is greater than or equal to 0.48 and less than or equal to 0.52, and z is a number that renders the compound charge neutral and is greater than about −0.1 and less than about 0.2. Preferred compositions have A predominantly representing La. Even more preferred compositions have B substantially representing Zr.

Although compounds described by the enumerated formula have been reported in the past as candidates for thermal barrier coatings on metallic substrates (U.S. Pat. No. 6,117,560 and U.S. Pat. No. 6,258,467), their use as heat exchangers has not previously been described.

In a fourth embodiment of the present invention the heat exchanger comprises a ceramic oxide material described by the formula
A₁₋ₓBₓO_{(3+x+z)/2}
where A is selected from the group consisting of La, Ce, Pr, Nd, Pm, Sm, Eu, Gd, Tb, Dy, Ho, Er, Tm, Yb, Lu, Y, and mixtures thereof and is at least representing La, B represents Zr, Ti or Hf or mixtures thereof and is at least representing Ti, x is equal to ⅓, and z is a number that renders the compound charge neutral and is greater than about −0.1 and less than about 0.2. Preferred compositions of the enumerated formula have B predominantly representing Ti. Even more preferred compositions have A predominantly representing La.

The invention will be further explained and envisaged in the following examples and figures.

FIG. 1 shows the vapour pressure above a selection of oxides in the presence of steam at a pressure of 12.7 bar and hydrogen at a partial pressure of 0.1 bar as a function of inverse temperature.

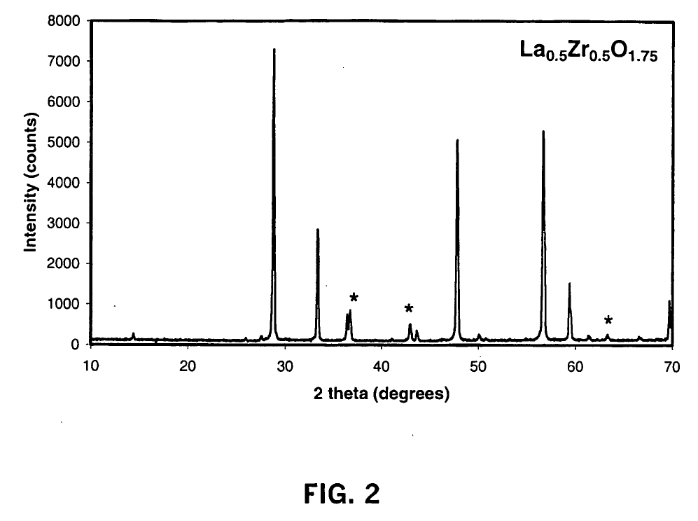

FIG. 2 shows the X-ray diffractogram of the heat exchanger material of Example 1, La_{0.5}Zr_{0.5}O_{1.75}. The asterix (*) indicate reflections from the aluminium sample holder.

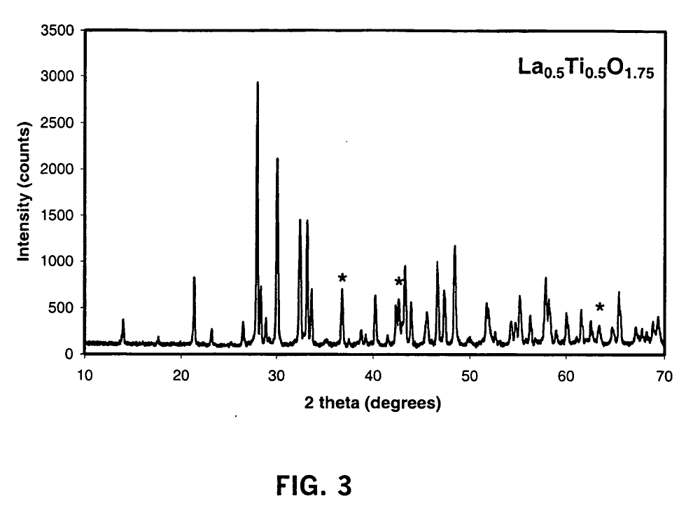

FIG. 3 shows the X-ray diffractogram of the heat exchanger material of Example 2, La_{0.5}Ti_{0.5}O_{1.75}. The asterix (*) indicate reflections from the aluminium sample holder.

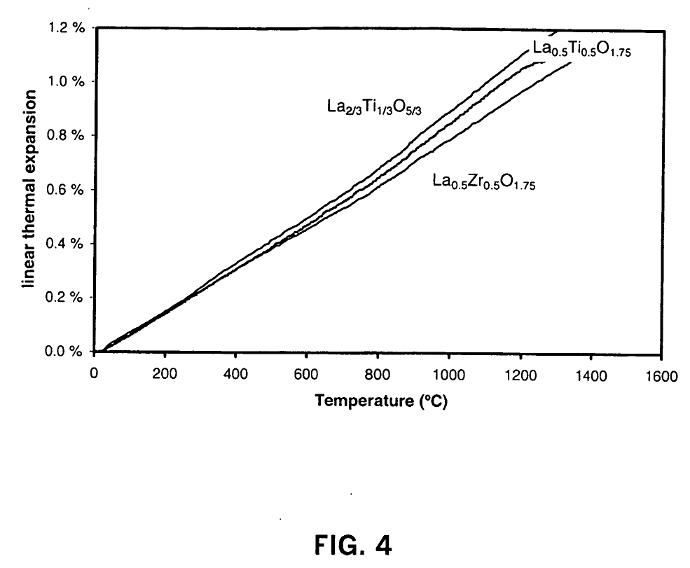

FIG. 4 shows the linear thermal expansion characteristics of the three heat exchanger materials of Examples 1-3, La_{0.5}Zr_{0.5}O_{1.75}, La_{0.5}Ti_{0.5}O_{1.75}, and La_{2/3}Ti_{1/3}O_{5/3.}

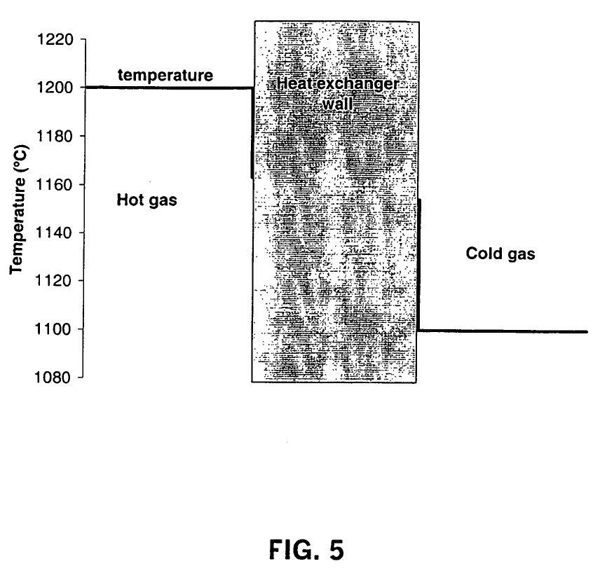

FIG. 5 shows the calculated temperature profile from the cold gas through the heat exchanger wall to the hot gas for a La_{0.5}Zr_{0.5}O_{1.75} heat exchanger. The calculations are described in Example 8.

### EXAMPLE 1

### Preparation of La_{0.5}Zr_{0.5}O_{1.75}

A ceramic oxide heat exchanger material was prepared by a soft chemistry route wherein the appropriate amount of La₂O₃ and ZrC₂₀H₂₈O₈ were first dissolved in nitric acid. To this liquid mixture was added citric acid in excess, and excess water was evaporated for 3 hours at 90° C., during which time complexation takes place. The resulting gel was dried in air for 14 hours by heating to 140° C., whereupon the organic matter was removed by subjecting the sample to 500° C. for 3 hours. The powder was calcined at 1300° C. for 10 hours and thereby ground in a planetary mill with grinding media of yttria stabilised zirconia. The powder mixture was then combined with a binder and uniaxially cold pressed to a Ø13 mm disk at 180 MPa. The resulting porous disk was heated to 500° C. at 3°/min in air to allow controlled combustion of the binder, and then further heated to 1600° C. in air, maintained at 1600° C. for 3 hours and cooled to room temperature. This procedure yielded a Ø10 mm disk with 97% of theoretical density. The formula representing the product may be expressed as La_{0.5}Zr_{0.5}O_{1.75}. The compound has a melting temperature higher than 2200° C.

### EXAMPLE 2

### Preparation of La_{0.5}Ti_{0.5}O_{1.75}

A ceramic oxide heat exchanger material was prepared according to the method of Example 1 except using TiC₂₀H₂₈O₈ instead of ZrC₂₀H₂₈O₈, and using calcination and sintering temperatures of 1200° C. and 1300° C., respectively, to yield a product that may be represented by the formula La_{0.5}Ti_{0.5}O_{1.75}. The procedure yielded a Ø10 mm disk with 98% of theoretical density. The compound has a melting temperature of around 1800° C.

### EXAMPLE 3

### Preparation of La_{2/3}Ti_{1/3}O_{5/3}

A ceramic oxide heat exchanger material was prepared according to the method of Example 2 except doubling the La₂O₃ to TiC₂₀H₂₈O₈ ratio and using a sintering temperature of 1400° C. to yield a product that may be represented by the formula La_{2/3}Ti_{1/3}O_{5/3}. The procedure yielded a Ø10 mm disk with >95% of theoretical density. The compound has a melting temperature of around 1700° C.

### EXAMPLE 4

### Preparation of Ti_{0.93}Zr_{0.07}O₂

A ceramic oxide heat exchanger material can be prepared according to the method of Example 1 except using the raw materials TiC₂₀H₂₈O₈ and ZrC₂₀H₂₈O₈, and using a calcination temperature of 1200° C. to yield a product that may be represented by the formula Ti_{0.93}Zr_{0.07}O₂. The compound has a melting temperature of above 1800° C.

### EXAMPLE 5

### Preparation of La_{0.85}Nd_{0.15}O_{1.5}

A ceramic oxide heat exchanger material can be prepared according to the method of Example 1 except using the raw materials La₂O₃ and Nd₂O₃ to yield a product that may be represented by the formula La_{0.85}Nd_{0.15}O_{1.5}. The compound has a melting temperature of above 1800° C.

### EXAMPLE 6

### Structure of La_{0.5}Zr_{0.5}O_{1.75} and La_{0.5}Ti_{0.5}O_{1.75}

XRD diffractograms of the heat exchanger materials of Examples 1 and 2 are shown in FIGS. 2 and 3. Both materials are single phase and possess the pyrochlore structure.

### EXAMPLE 7

### Thermal Expansion of La_{0.5}Zr_{0.5}O_{1.75}, La_{0.5}Ti_{0.5}O_{1.75}, and La_{2/3}Ti_{1/3}O_{5/3}

The heat exchanger material disks of Examples 1-3 were mounted in a Bähr DIL801L dilatometer, and heated at 6° C./min to 1400° C., while the relative change in length of the samples were recorded. The resulting linear thermal expansion characteristics of the three heat exchanger materials, La_{0.5}Zr_{0.5}O_{1.75}, La_{0.5}Ti_{0.5}O_{1.75}, and La_{2/3}Ti_{1/3}O_{5/3}, are shown in FIG. 4.

### EXAMPLE 8

### Calculation of Heat Transfer in a La_{0.5}Zr_{0.5}O_{1.75} Heat Exchanger

Calculation of heat transfer in a La_{0.5}Zr_{0.5}O_{1.75} heat exchanger was performed, assuming a thermal conductivity (k) of 1 W/(mK) for the La_{0.5}Zr_{0.5}O_{1.75} material. For the calculation laminar flow between plates of 1 m length, 1 mm thickness (d) and 2 mm spacing was assumed. The total pressure was 20 bar and the gas velocities 1 m/s. The high temperature gas contained 67% steam and 33% carbon dioxide at a temperature (T₄) of 1200° C., while the low temperature gas consisted of air at a temperature (T₀) of 1100° C. Standard equations gave heat transfer coefficients (h_{c}) of 242 W/(m²K) for the hot gas and 164 W/(m²K) for the cold gas. The heat transfer across the heat exchanger walls was then calculated by using the equations:
q=h_{c0}*(T₁−T₀)
q=k*(T₂−T₁)/d
q=h_{c4}*(T₄−T₃)
where q is the heat flux, h_{c0} is the heat transfer coefficient near the cold wall, h_{c4} is the heat transfer coefficient near the hot wall, and T₁ and T₂ the cold and hot wall temperatures, respectively.

The calculations gave a heat flux of 8.9 kW/m² and showed that only 9% of the overall temperature difference between the gases occurred in the heat exchanger wall. The remaining 91% occurred in the solid-gas interfaces. The temperature profile from the cold gas through the wall to the hot gas is shown in FIG. 5.

A similar calculation with a heat exchanger material with a thermal conductivity (k) of 100 W/(mK) gave a heat flux of 9.8 kW/m². Therefore, the thermal conductivity is of minor importance to the overall heat transfer.

1-10. (Cancel)

11. A ceramic heat exchanger manufactured from an oxide material represented by the formula:
A₁₋ₓBₓO_{(3+x+z)/2}
where A is selected from the group consisting of La, Ce, Pr, Nd, Pm, Sm, Eu, Gd, Tb, Dy, Ho, Er, Tm, Yb, Lu, Y, and mixtures thereof, B represents Zr, Ti or Hf or a mixture thereof, x is greater than or equal to zero and less than one, and z is a number that renders the compound charge neutral and is greater than about −0.1 and less than about 0.2.

12. A ceramic heat exchanger according to claim 11, wherein x is equal to zero.

13. A ceramic heat exchanger according to claim 12, wherein A is predominantly La.

14. A ceramic heat exchanger according to claim 11, wherein x is greater than or equal to 0.48 and less than or equal to 0.52.

15. A ceramic heat exchanger according to claim 14, wherein A is predominantly La.

16. A ceramic heat exchanger according to claim 15, wherein B is substantially Zr.

17. A ceramic heat exchanger according to claim 11, wherein x is equal to ⅓, A is at least La, and B is at least Ti.

18. A ceramic heat exchanger according to claim 17, wherein B is predominantly Ti.

19. A ceramic heat exchanger according to claim 18, wherein A is predominantly La.
